(19) United States
(12) Patent Application Publication
(10) Pub. No.: US 2004/0173050 A1
(43) Pub. Date: Sep. 9, 2004

(54) Camshaft assembly

(76) Inventors: Jochen Asbeck, Attendorn (DE); Henning Blocker, Stelle (DE)

Correspondence Address: Robert P. Renke, Suite 250, 28333 Telegraph Road, Southfield, MI, 48034, US

(21) Appl. No.: 10/763,458

(22) Filed: Jan. 23, 2004

(30) Foreign Application Priority Data
Jan. 24, 2003 (DE) 103 02 957.5-12

(51) Int. Cl. F16C 3/04

(52) U.S. Cl. 74/595

(57) ABSTRACT

A camshaft assembly (11) having a tubular shaft (12) and a plurality of cams (14) which are each provided with a through-aperture and which are slid on to the tubular shaft (12) and secured thereto at distances from one another, wherein the tubular shaft (12), between the cams (14), includes inwardly hot-formed lateral indentations (22). A method and device for producing the camshaft assembly are also provided.

### TECHNICAL FIELD

The invention relates to an assembled camshaft having a tubular shaft and a plurality of cams which are each provided with a through-aperture and which are slid on to the tubular shaft and secured thereto at distances from one another.

### BACKGROUND OF THE INVENTION

Camshafts of this type are becoming increasingly popular for high-performance engines because of their lightweight characteristics and because they allow a greater degree of freedom when selecting the material. The production processes for camshafts of this type are described in U.S. application Publication No. 2003/0150095 wherein the deformation of the individual longitudinal portions of the tubular shaft takes place sequentially by applying, in a locally delimited region, a high hydraulic internal pressure inside the slid-on cams. Cross-sectional enlargements are formed in smooth cylindrical through-apertures of the cams in order to produce press-fits between the tubular shaft and the cams.

In the case of cylinder heads of engines with two camshafts, the installation conditions in the cylinder head are often restricted. The through-holes for receiving the cylinder head screws, by necessity, are positioned closely to the camshafts, so that, in a plan view of the cylinder head, the through-holes are partially covered by the camshafts. According to production requirements, the camshafts have to be finish-mounted in the cylinder head before the cylinder head is placed on to the cylinder crank housing and bolted thereto. In the case of cylinder heads with the above-mentioned characteristics, the latter cannot be achieved because the access to the through-holes is blocked. It can only be achieved by using special types of camshafts which have lateral indentations in the region of the through holes, which indentations reduce the cross-section of the camshaft in this region fillet-like and permit the use of tools for the cylinder head screws for a camshaft which has already been assembled. As a result, it is possible to mount finished cylinder heads and to retighten the cylinder head screws without having to remove the camshafts.

DE 201 16 112 U1 proposes a method of producing assembled camshafts with the above-mentioned indentations, according to which method the tubular shaft is first inserted into a complete die without the cams. The die encloses the complete tubular member in a play-free way and in the die there are guided individual rams. The rams, at their front ends, comprise semi-cylindrical formations extending transversely to the longitudinal axis of the tubular member, which front ends can be introduced into the die cavity. First, the ram is used to form indentations in the tubular shaft inserted into the die, with the accurately fitting position of the tubular shaft in the die ensuring that no bulgings can occur during deformation next to the indentations. The cams are then slid on to the tubular shaft which is provided with indentations and whose cross-section is held by the die so as to remain substantially unchanged. The cams are secured on the tubular shaft by one of the available joining processes. The initially mentioned joining process, however, for securing the cams by producing cross-sectional enlargements at the tubular member cannot be used in this case because pressure probes can no longer be inserted into the deformed tube. Thus, there exists a need for an improved tubular camshaft assembly process.

### SUMMARY OF THE INVENTION

The present invention provides an assembled camshaft of the foregoing type which can be produced by any joining process, as well as a process and device for deforming the tubular shaft to assemble such camshafts. The invention provides an assembled camshaft having a tubular shaft and a plurality of cams which are each provided with an aperture and which are slid on to the tubular shaft and secured thereto at distances from one another. Between the cams, the tubular shaft comprises inwardly hot-formed lateral indentations which form free assembly spaces for tools and screws/bolts respectively. The design disclosed herein makes it possible to produce finish-assembled camshafts of the desired type with additional local deformations for providing free assembly spaces in which the fixing security of the already joined cams is not at risk. Differently produced deformations of the longitudinal portions between the already joined cams would necessarily endanger the fixing of the cams. As any loosening of the cam from the tubular shaft during the operation of the engine would lead to significant, if not catastrophic engine damage, this would be totally impermissible.

In one embodiment, at the indentations, there are formed projections which surround the indentations and which increase the outer diameter of the tubular shaft beyond the cross-section of the through-apertures of the cams. In this way, it is possible to readily deform the tubular member. Furthermore, in the region of the cams, the tubular shaft can comprise cold-formed circumferential cross-sectional enlargements for securing the cams. It is thus possible to use the initially mentioned preferred joining technology for the cams by applying, in locally delimited regions, a high hydraulic internal pressure to the tubular shaft.

Furthermore, the cross-sectional enlargements can cooperate with smooth cylindrical through-apertures of the cams, and extend concentrically relative to the tubular shaft and form press-fits together with the cams. More particularly, the cross-sectional enlargements can each extend at least along the axial length of a cam. According to an alternative embodiment, the regions surrounding the indentations do not substantially exceed the original outer diameter of the tubular shaft. This requires that deformation has to take place in a die, which permits the cams to be slid on to and joined to the tubular shaft. Even before the cams are slid on and joined, however, the tubular shaft, in the regions of the cams, can be given surface projections for securing the cams, which surface projections increase the cross-section.

In a further embodiment, the lateral indentations extend transversely to the length of the tubular shaft. More particularly, the indentations can correspond to approximately part- or semi-cylindrical penetrations of the tubular shaft. The indentations at the inside of the tube can extend approximately as far as the tube axis.

Even in this case, however, because the indentations are produced in the tubular shaft in accordance with the invention, hot forming results in a product wherein the cams are securely fixed as required. As far as their circumferential position is concerned, the indentations can all be orientated in the same way.

Furthermore, the present invention provides a process of producing an assembled camshaft having a tubular shaft and a plurality of cams which are each provided with a through-aperture and which are slid on to the tubular shaft and secured thereto at distances from one another, wherein the tubular shaft is locally heated between the fixed cams and provided with lateral indentations by hot-forming.

According to one embodiment of the method, hot-forming takes place at the tubular member which is not clamped in, wherein at the indentations there are formed projections which surround the indentations and which increase the outer diameter of the tubular shaft beyond the cross-section of the through-apertures of the cams. The joining process can include that, before producing the indentations, the tubular shaft, in the region of the cams, is radially outwardly cold-formed by increasing the cross-section in the region of the cams.

In this way, first, the camshaft is assembled in a way known in itself wherein, apart from the cams mentioned here optionally also gears and other elements can be slid on and secured to the tubular shaft, with the deformation process for producing the indentations only taking place subsequently. Because deformation takes place on the free unsupported tubular shaft, radial projections can occur at the tubular shaft without adversely affecting the free selection of the joining technology for the cams. The indentations can also serve purposes other than those primarily mentioned here.

As is known in principle, the cross-sectional enlargement can be produced, more particularly sequentially, by applying hydraulic internal pressure to the tubular member in order to form press-fits with the cams. The second longitudinal portions positioned between the cams are also preferably sequentially deformed for producing the indentations, by introducing a local mechanical force to the heated tubular member, which force is directed substantially radially relative to the tube axis.

As already indicated, it is possible, according to an alternative embodiment, for hot forming to take place at the tubular member which is clamped into a die, as a result of which the regions surrounding the indentations are clamped into the die in such a way that they cannot substantially exceed the original outer diameter of the tubular shaft. To simplify the die, the tubular shaft can be deformed prior to sliding on the cams, and only after the indentations have been formed are the cams slid on to the tubular shaft and secured thereto.

Local hot forming in accordance with the invention can lead to tensile stresses in the tubular member when the material cools down. These tensile stresses lead to a bend in the tubular member in each of the hot-formed indentations. In order to avoid the required straightening of the finished camshaft, during the local introduction of force a bending moment is introduced into the tubular member around an axis which extends perpendicularly relative to the direction of force application in order to produce a bend in the tubular shaft whose center is positioned on the opposite side relative to the introduction of local mechanical force. More particularly, the dimensions of the bend of the heated tubular member can be selected to be such that the longitudinal axis of the tubular shaft is again aligned after the tubular member has cooled down. This means that during the hot forming operation, the deformed region is simultaneously bent against the shrinkage and tensile stresses expected during the cooling process, i.e. the subsequent bending effect during the cooling process is anticipated during the hot forming process by generating a counter bend.

For carrying out local heating, in principle, different processes are available which permit relatively delimited local heating. According to a first embodiment, a tubular shaft, between the cams, is heated in a locally delimited region by a flow of current passing over the tubular shaft by using the method of electric resistance heating. For example, the flow of current in the tubular shaft can be locally delimited between at least two radially opposed electrodes at the tubular shaft and can take place substantially transversely to the tube axis, wherein one of the electrodes is used for locally introducing a mechanical force. In this embodiment, a forming tool is simultaneously used as an electrode. According to a further embodiment, a flow of current in the tubular shaft is locally delimited between two electrodes arranged at the tubular shaft at axial distances from one another and takes place substantially longitudinally relative to the tube axis, wherein the electrodes preferably do not participate in the introduction of force. This is advantageous as far as the durability of the electrodes is concerned because, due to larger surface areas, the current density is reduced. Furthermore, the region to be heated can be axially narrower.

In addition, it can be advantageous that while heating the longitudinal portions provided for producing the indentations, the longitudinal portions carrying the cams, by being cooled, are held at a temperature which prohibits changes in structure or in stress in the material of the tubular shaft in the latter longitudinal portions. This is advantageous in order to avoid losses of strength of the pre-stressed cross-sectional enlargements in the region of the cams. Furthermore, all longitudinal portions provided for forming the indentations can be deformed in one single clamping-in situation of the camshaft, with there being available either a number of forming punches which corresponds to the number of indentations to be produced. Alternatively, in the clamping-in situation, the camshaft can be axially moved relative to one single forming tool or, vice versa, the single forming tool can be moved along the clamped camshaft.

A device is disclosed for producing lateral indentations in an assembled camshaft consisting of a tubular shaft and a plurality of cams which are each provided with a through-aperture and which are slid on to the tubular shaft and secured thereto at distances from one another. The device includes a clamping device for the camshaft, at least one heating device which permits local heating of individual second longitudinal portions between the cams, and at least one forming punch for radially locally introducing mechanical force into the heated tubular member for carrying out a hot-forming operation between the cams. More particularly, the clamping device can comprise several lower supporting bearing shells and several upper supporting bearing shells and an axial fixing device and a fixing device for angles of rotation. In one embodiment, the at least one forming punch, towards the tubular shaft, comprises an approximately semi-cylindrical cross-section whose axis intersects the longitudinal axis perpendicularly. Furthermore, the heating device can be a resistance heating device wherein electrodes are positioned at the tubular member and wherein current flows over the tubular shaft. In this embodiment, it is possible either for a first electrode to be formed by the at least one forming punch and for several second electrodes to be formed by the lower supporting bearing shells, or for one first electrode to be axially arranged on one side of the at least one forming punch and for a second electrode to be axially arranged on the other side of the at least one forming punch. The electrodes can also be annular electrodes. To avoid the above-mentioned bending effects, in a longitudinal section through the center line of the clamping device, defined by the centers of the supporting bearing shells, the lower supporting bearing shells comprise an external curvature which points towards the forming punch. In another embodiment, lower supporting bearing shells and upper supporting bearing shells are alternately arranged so as to be axially spaced relative to one another along the longitudinal axis of the clamping device. In a further example, relative to two adjoining upper supporting bearings, the lower supporting bearing shells are individually displaceable towards the forming punch relative to the longitudinal axis of the clamping device. Alternatively it is possible for the center line of the clamping device, defined by the centers of the supporting bearing shells, to form a bent line which delimits a plane together with the axis of feed of the forming punch and whose outer curvature points towards the forming punch, i.e. whose bending center is arranged opposite the forming punch, with reference to the bent line.

Other advantages and features of the invention will become apparent to one of skill in the art upon reading the following detailed description with reference to the drawings illustrating features of the invention by way of example.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows an inventive camshaft according to one embodiment:

A) in a longitudinal section;

B) in an axial view; and

C) in a cross-sectional view.

FIG. 2 shows an inventive device with a clamped-in camshaft in a first embodiment.

FIG. 3 shows an inventive device with a clamped-in camshaft in a second embodiment:

A) in a longitudinal section; and

B) in a cross-section through the forming punch and an upper supporting bearing.

FIG. 4 shows an inventive device with a clamped-in camshaft in a third embodiment.

FIG. 5 shows a segment of an inventive device in a further embodiment:

A) in a longitudinal section through the forming punch;

B) in a cross-section through an electrode;

C) in a cross-section through a lower supporting bearing; and

D) in a plan view.

FIG. 6 shows an inventive device with a clamped-in camshaft in a fourth embodiment:

A) in a longitudinal section; and

B) in a cross-section through an electrode.

### DETAILED DESCRIPTION OF THE DRAWINGS

In the following description, various operating parameters and components are described for several embodiments. These specific parameters and components are included as examples and are not meant to be limiting. Also, in the following figures, the same reference numerals will be used to refer to the same components.

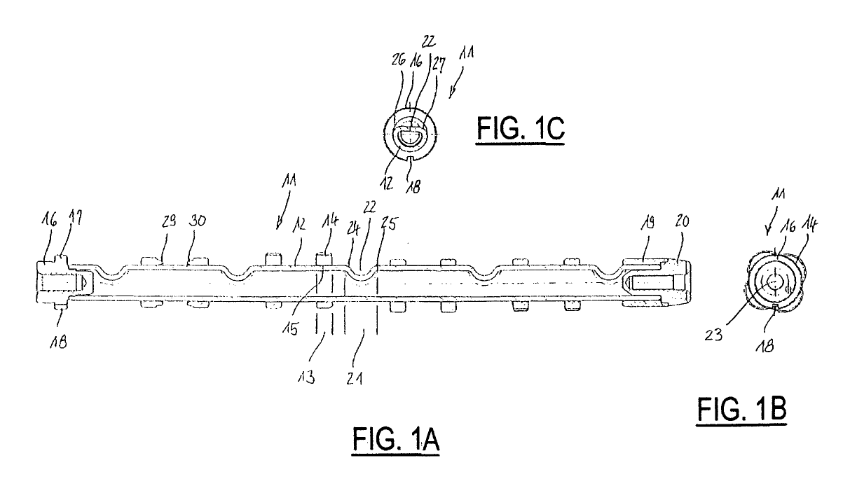

The different illustrations in FIG. 1 will be described jointly below. They show an inventive assembled camshaft 11 which, substantially, includes a tubular shaft 12 and pairs of cams 14 slid on to the tubular shaft 12. The cams 14 include through-apertures 15 for sliding on the tubular shaft 12. The cams 14 are fixed in pairs in different angular positions on the tubular shaft 12. For this purpose, the tubular shaft 12 is radially expanded by cold forming in first longitudinal portions 13 associated with the cams 14, so that the cams 14 are secured by a press-fit on axially delimited cross-sectional enlargements of the tubular shaft 12. The cold-formed cross-sectional enlargements cooperate with the smooth cylindrical through-apertures 15 of the cams 14 and extend concentrically relative to the tubular shaft 12. They form press-fits with the interior surface of the through-aperture 15 of the cams 14. These cross-sectional enlargements extend axially at least as long as the axial length of the cam 14 to which it engages. These details cannot be readily identified in the Figures, however, because of the present drawing scale. At the first end of the tubular shaft 12 there is inserted a plug 16 with a collar 17 provided with a notch 18 which, inter alia, can be used for accurately angularly fixing a driving pinion. Such a driving pinion for driving the camshaft 11 can be slid on to the plug 16. A sleeve 19 is slid on to the second end of the tubular shaft 12 and, additionally, there is inserted a plug 20, and the sleeve 19 can serve as a bearing. Between each two pairs of cams 14 and between the axially outer cams and the plugs 16, 19, the tubular shaft 12 is marked by second longitudinal portions 21 of the camshaft 11 in which there are formed indentations 22. The indentations approximately correspond to semi-cylindrical penetrations whose axes perpendicularly intersect the longitudinal axis 23 of the camshaft 11. In contrast to the cams 14, the indentations 22 are all orientated in the same way relative to their circumferential position, with the unillustrated axes of the semi-cylindrical penetrations being positioned perpendicularly relative to the drawing plane. All regions of transition at the indentations 22 comprise rounded portions 24, 25 in the longitudinal section and rounded portions 26, 27 in the cross-section, i.e. they do not comprise sharp edges. The rounded portions 24, 25 are positioned at an adequate distance from the nearest cams 14. The indentations 22 allow bolts and threaded tools whose axes extend perpendicularly relative to the drawing plane to be moved very closely to the longitudinal axis 23 of the camshaft 11. In certain engine types, this is necessary for fitting a cylinder head in cases where the camshaft has already been mounted in the cylinder head. The left-hand pair of cams 14 is shown to comprise inner collars 29, 30 which are used for axially supporting the camshaft 11 in the cylinder head and for axial fixing purposes during the production of the indentations.

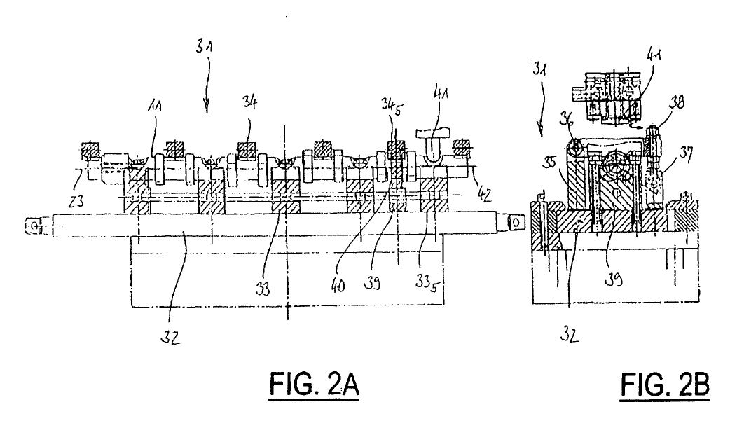

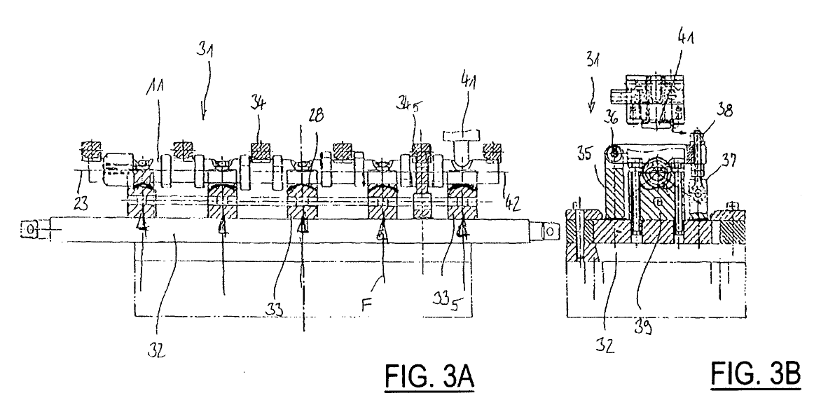

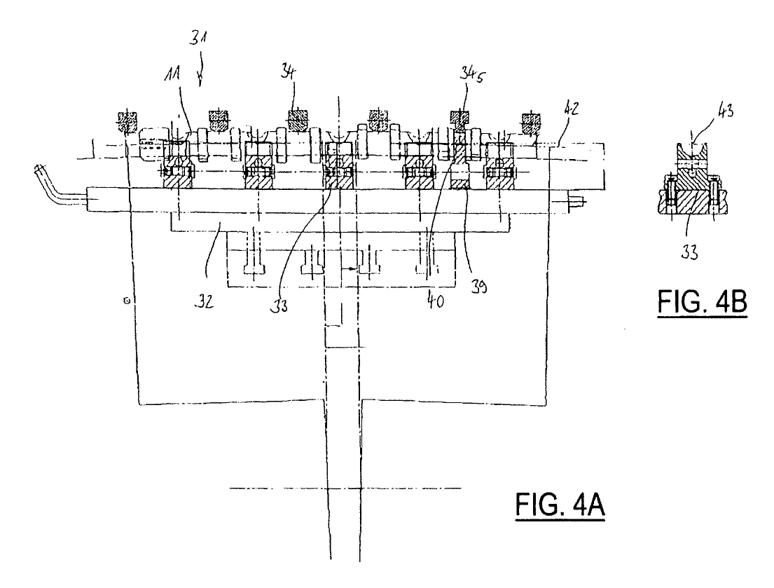

FIGS. 2 to 4 will initially be described jointly in respect of all identical details. Details which deviate from one another will be explained subsequently. The Figures each show a clamping device 31 into which there is clamped a camshaft 11. The device comprises a table or slide 32 which, in turn, comprises a plurality of six lower supporting bearings 33 axially fixed relative to one another and a plurality of six upper supporting bearings 34 axially fixed relative to one another. The lower supporting bearings 33 and the upper supporting bearings 34 are axially offset relative to one another, i.e. they are staggered symmetrically relative to one another. The lower supporting bearings 33 support the second longitudinal portions 21 where the indentations are to be produced. The upper supporting bearings 34 clamp the camshaft 11 between two cams 14 of a pair of cams as well as at the ends of the tubular shaft 12. The upper supporting bearings can be pivoted away, as can be seen in the cross-sectional view in FIGS. 2 and 3, wherein the pivotable supporting bearing comprises a pivot pin or journal 36 supported in the first block 35 and a clamping mechanism 38 supported in a second block 37. Underneath the fifth upper supporting bearing 34₅ (from the left) there is additionally provided a fixing block 39 on which the camshaft 11 can be axially accurately positioned by means of collars 29, 30. A fixing device 40 which cooperates with at least one cam and accurately determines the angular position of the camshaft. Above the last lower supporting bearing 33₅ (from the left), there is shown a forming punch 41 which, in FIGS. 2 and 3, is shown in a downwardly displaced position in FIGS. 2A and 3A and in an upwardly withdrawn position in FIGS. 2B and 3B. FIG. 4 shows one of the lower supporting bearings 33 in a cross-sectional view. In the embodiments explained here, the forming punch 41 forms the upper electrode and the lower supporting bearings 33 form the second electrodes whose half-dish-shaped surfaces, in their entirety, are larger than the surface of the forming punch 41 which comes into contact with the tubular shaft 12. This means that the current density at the forming punch is very much greater than at the lower supporting bearings. The current flows transversely to the tube axis to the lower supporting bearing 33₅, but also along the tube axis 23 to the further supporting bearings 33₁-33₄.

The devices shown here, with the slide 32 being in a fixed position, can comprise a single forming punch 41 which can be moved along the camshaft and which carries out the individual forming stages one after the other. Alternatively, in these devices, with the forming punch 41 being in a fixed position, the slide 32 can be moved along the tube axis for the purpose of carrying out the individual forming stages.

In FIGS. 2 and 3, the supporting bearings 33, 34 are all aligned relative to the longitudinal axis of the camshaft 11. In the embodiment according to FIG. 2, all the lower supporting bearings 33 are fixed relative to the slide 32. When the tubular shaft cools down, the hot-formed indentations can shrink, so that the tube has a tendency, at every indentation, to suffer a bend around the indentation in the drawing plane, with the center of the bend being positioned above the tubular shaft.

In the embodiment according to FIG. 3, the lower supporting bearings, in a longitudinal section, are provided with an external curvature 28 which is opposed to the forming punch 41, and as indicated by individual arrows F, during the forming process, they are individually slightly movable, i.e. radially relative to the tube axis and in the direction opposed to the forming punch 41. In this way it is possible, during the operation of hot-forming the tubular shaft, to force a bend at each indentation in the drawing plane in the direction opposed to the application of force at the forming punch, with the center of said bend being positioned underneath the tubular shaft. It is thus possible for the tube to straighten itself automatically during the subsequent cooling and shrinking processes of the hot-formed indentations, with the tube axis subsequently being re-aligned.

For simplicity, FIG. 4 does not show the forming punch, but it should be assumed that it is designed in the same way and functions in the same way as the punches shown in FIGS. 2 and 3. In this embodiment, the centers of the upper supporting bearings 34 and of the lower supporting bearings 33 are not aligned relative to one another and to the longitudinal axis of the camshaft. However, their centers 43, in their entirety, are positioned on a curved center line 42 which forms an upwardly pointing circular arch positioned in the drawing plane. In this case, too, the effect is that, in the course of the tubular shaft being hot-formed, a bend is formed on to the region being deformed, which bend is positioned in the drawing plane and is orientated in the direction opposed to the direction of force application of the forming punch. The center of the bend is located underneath the tubular shaft, so that, when the hot-formed indentation subsequently cools down, the tube axis is automatically straightened as a result of the shrinkage in the region of the indentation.

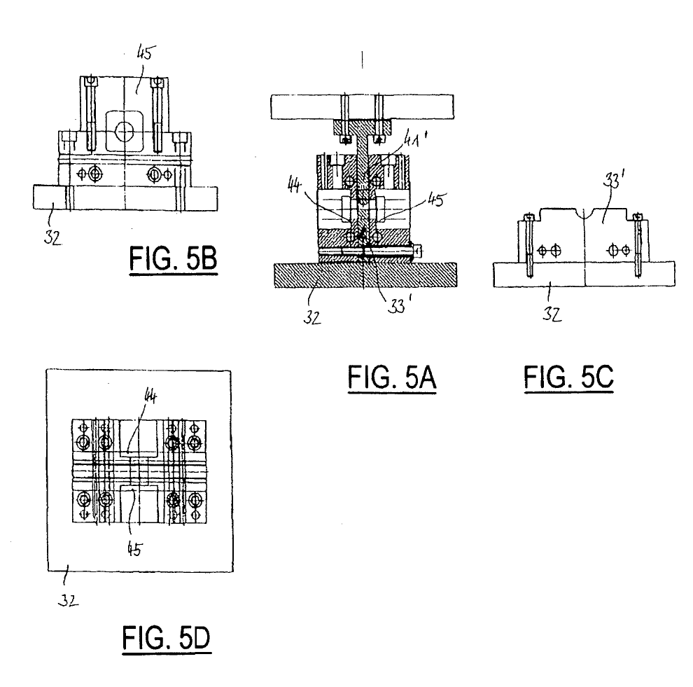

FIG. 5, in a modified embodiment, shows only part of a device according to the previous Figures in the region of the forming punch 41′. The forming punch 41′ and the associated lower supporting bearing 33′ comprise of a non-conducting material. On both sides of the above-mentioned two parts, there are provided divisible annular electrodes 44, 45 which are insulated relative to one another, but which, on the one hand, can be connected to a positive pole of a voltage source and, on the other hand, to a negative pole of a voltage source. This results in a flow of current towards the tubular shaft, which flow of current can be closely axially limited to a region between two cams. The forming punch 41′ is not switched to form an electrode, which advantageously affects its durability. In this embodiment, too, the lower supporting bearing 33′ can be designed to be radially movable towards the tube axis opposite to the forming punch 41′.

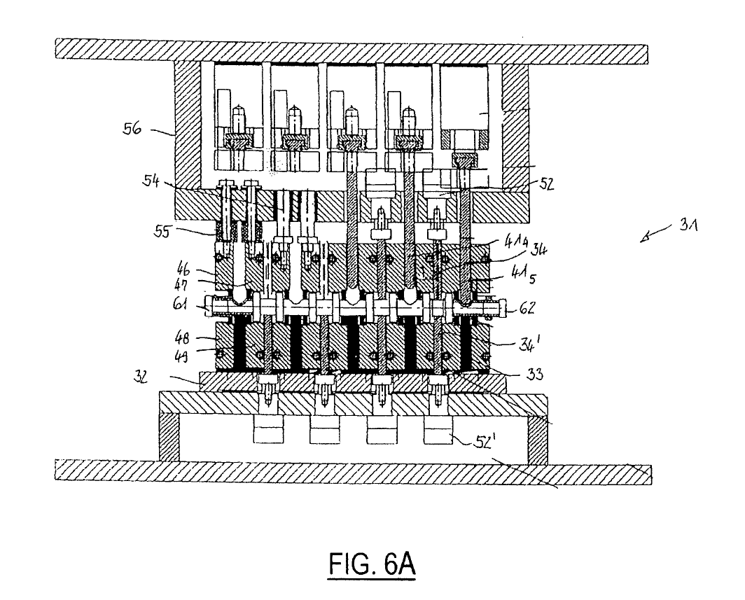

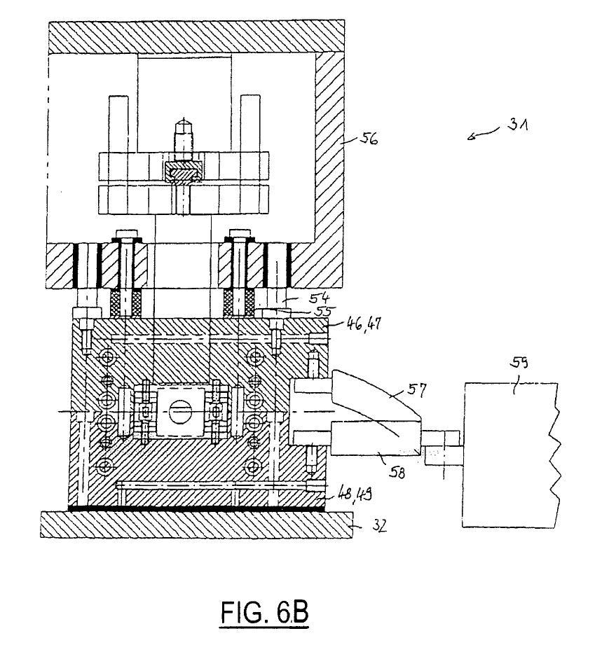

The two illustrations of FIG. 6 will be described jointly below. FIG. 6 shows a clamping device 31 which clamps in a camshaft 11. The device comprises a table 32, a plurality of five lower supporting bearings 33 which are axially fixed relative to one another and four pairs of upper and lower supporting bearings 34, 34′ which are axially fixed relative to one another. The lower supporting bearings 33 and the pairs of upper and lower supporting bearings 34, 34′ are arranged so as to axially alternate. The lower supporting bearings 33 support the second longitudinal portions 21 in which the indentations 22 are to be produced. The pairs of upper and lower supporting bearings 34, 34′ clamp the camshaft 11 between two cams 14 of a pair of cams. The upper supporting bearings 34 are held in upper setting cylinders 52 and the lower supporting bearings 34′ are held in lower setting cylinders 52′. Above the lower supporting bearings 33, there are shown three of a total of five forming punches 41, of which the forming punch 41 shown in FIG. 6A on the right, is shown in a downwardly displaced position. The two other forming punches 41 are shown in an upwardly withdrawn position. The forming punches 41 are held by a holding device 51 in feed cylinders 53. Pairs of upper electrode holding devices 46, 47 and pairs of lower electrode holding devices 48, 49 are arranged so as to adjoin the forming punches 41 and the lower supporting bearings 33, into which holding devices 46, 47; 48, 49 there are inserted electrodes with semi-dish-shaped surfaces which are in contact with the camshaft. The upper electrode holding devices 46, 47 are held in a guide 54 and held by elastic elements 55 such as a bearing in a bracket 56. Axially adjustable journals 61, 62 engage the ends of the camshaft 11 and secure the axial position of same. FIG. 6B shows that the electrode holding devices 46, 47; 48, 49 are connected via an electric cable 57, 58 to a transformer 59.

From the foregoing, it can be seen that there has been brought to the art a new and improved camshaft assembly and device and method for assembling a camshaft. While the invention has been described in connection with one or more embodiments, it should be understood that the invention is not limited to those embodiments. Thus, the invention covers all alternatives, modifications, and equivalents as may be included within the spirit and scope of the appended claims.

What is claimed is:

1. A camshaft assembly comprising a tubular shaft and a plurality of cams which are each provided with an aperture and which are slid on to the tubular shaft and secured thereto at distances from one another, wherein, between the cams, the tubular shaft comprises inwardly hot-formed lateral indentations.

2. A camshaft according to claim 1, wherein, at the indentations, there are formed projections which surround said indentations and which increase the outer diameter of the tubular shaft beyond the cross-section of the through-apertures of the cams.

3. A camshaft according to claim 1, wherein, in the region of the cams, the tubular shaft comprises cold-formed circumferential cross-sectional enlargements for securing the cams.

4. A camshaft according to claim 3, wherein the cross-sectional enlargements cooperate with smooth cylindrical through-apertures of the cams, extend concentrically relative to the tubular shaft, and form press-fits together with the cams.

5. A camshaft according to claim 4, wherein the cross-sectional enlargements each extend at least along the axial length of a cam.

6. A camshaft according to claim 1, wherein regions adjacent the indentations have substantially the same outer diameter as the tubular shaft.

7. A camshaft according to claim 6, wherein, in the region of the cams, the tubular shaft comprises surface projections for securing the cams, the surface projections increasing the cross-sectional dimension of the tubular shaft.

8. A camshaft according to claim 1, wherein the lateral indentations extend transversely to the length of the tubular shaft.

9. A camshaft according to claim 1, wherein the indentations approximately correspond to partial-cylindrical penetrations of the tubular member.

10. A camshaft according to claim 1, wherein the indentations, at an inner face of the tube, approximately extend as far as to the longitudinal tube axis.

11. A camshaft according to claim 1, wherein the indentations are all orientated in the same way with respect to their circumferential position on the tubular shaft.

12. A method of producing a camshaft comprising:
providing a tubular shaft;
sliding a plurality of cams, each having a through-aperture, onto the tubular shaft;
securing the cams onto the tubular shaft at defined distances from each other;
locally heating the tubular shaft between at least two cams; and
hot-forming a lateral indentation in the shaft in the locally heated region.

13. A method according to claim 12 comprising forming projections surrounding the indentation to increase the outer diameter of the tubular shaft beyond the cross-section of the through-apertures of the cams.

14. A method according to claim 12 comprising, after the step of sliding and prior to hot-forming, radially outwardly cold-forming cross-sectional enlargements on the tubular shaft in the region of at least one cam.

15. A method according to claim 14 wherein the step of cold-forming includes sequentially applying a hydraulic internal pressure to the tubular shaft to form press-fits with the cams.

16. A method according to claim 12 wherein the step of hot-forming occurs with the tubular shaft clamped in a die such that in regions adjacent the indentation, the original outer diameter of the tubular shaft is substantially maintained.

17. A method according to claim 12 wherein the cams are slid onto the shaft after the step of hot-forming the indentations.

18. A method according to claim 12 wherein the indentations are formed sequentially by introducing local mechanical force at the locally heated region in the radial direction relative to the longitudinal axis of the shaft.

19. A method according to claim 18 comprising, during the step of introducing, providing a bending moment into the tubular shaft around an axis perpendicular relative to the direction of the mechanical force to cause a bend of the tubular shaft, wherein the center of the bend is positioned on a side opposing the mechanical force.

20. A method according to claim 19 wherein the bend is dimensioned such that, after cooling, the longitudinal axis of the tubular shaft is aligned.

21. A method according to claim 12 wherein the step of locally heating includes electric resistance heating a locally delimited region of the tubular shaft.

22. A method according to claim 21 wherein a flow of current is locally delimited between at least two opposed electrodes at the tubular shaft and occurs substantially transversely to the longitudinal axis of the shaft.

23. A method according to claim 22 comprising introducing a mechanical force on the shaft with at least one of the electrodes.

24. A method according to claim 12 comprising, while locally heating, maintaining longitudinal portions of the shaft carrying the cams at a temperature which prohibits changes in structure or stress in the shaft at said portions.

25. A method according to claim 12 wherein all hot-formed indentations are formed simultaneously.

26. An apparatus for producing lateral indentations in an assembled camshaft having a tubular shaft and a plurality of cams which are each provided with a through-aperture and which are slid on to the tubular shaft and secured thereto at distances from one another, the apparatus comprising:
a clamping device for the camshaft;
at least one heating device which permits local heating of individual longitudinal portions between the cams; and
at least one forming punch for radially locally introducing mechanical force into the heated tubular member for carrying out a hot-forming operation between the cams.

27. An apparatus according to claim 26, wherein the clamping device comprises several lower supporting bearing shells and several upper supporting bearing shells, an axial fixing device, and a fixing device for angles of rotation.

28. An apparatus according to claim 26, wherein the at least one forming punch, towards the tubular shaft, comprises an approximately semi-cylindrical cross-section whose axis crosses the longitudinal axis of the shaft perpendicularly.

29. An apparatus according to claim 26, wherein the heating device is a resistance heating device including electrodes positioned at the tubular member and wherein current flows via the tubular shaft.

30. An apparatus according to claim 29, wherein a first electrode is formed by the at least one forming punch and a second electrode is formed by a lower supporting bearing shell.

31. An apparatus according to claim 29, wherein one first electrode is axially arranged on one side of the at least one forming punch and a second electrode is axially arranged on the other side of the at least one forming punch.

32. An apparatus according to claim 31, wherein the electrodes are annular electrodes.

33. An apparatus according to claims 27, wherein, in a longitudinal section through a center line of the clamping device, defined by the centers of the supporting bearing shells, the lower supporting bearing shells comprise an external curvature which points towards the forming punch.

34. An apparatus according to claims 27, wherein the lower supporting bearing shells and upper supporting bearing shells are alternately arranged so as to be axially spaced relative to one another.

35. An apparatus according to claim 34, wherein relative to two adjoining upper supporting bearing shells, the lower supporting bearing shells are individually displaceable towards the forming punch relative to the longitudinal axis of the clamping device.

36. An apparatus according to claim 27, wherein a center line of the clamping device, defined by the centers of the supporting bearing shells, forms a bent line which, together with a feed axis of the forming punch, delimits a plane and whose outer curvature points towards the forming punch.
